(19) United States
(12) Patent Application Publication
(10) Pub. No.: US 2017/0004907 A1
(43) Pub. Date: Jan. 5, 2017

(54) MULTI-CORE CABLE

(71) Applicant: SUMITOMO ELECTRIC INDUSTRIES, LTD., Osaka (JP)

(72) Inventors: Yoshimasa WATANABE, Tochigi (JP); Hiroshi UMETSU, Tochigi (JP); Kazuhiro SATO, Tochigi (JP)

(21) Appl. No.: 15/178,782

(22) Filed: Jun. 10, 2016

(30) Foreign Application Priority Data
Jul. 2, 2015 (JP) 2015-133278

(51) Int. Cl. H01B 17/12; H01B 7/02

(52) U.S. Cl. CPC H01B 17/12; H01B 7/02

(57) ABSTRACT

A multi-core cable includes a plurality of electric wires, a jacket for covering the peripheries of the electric wires, and a strain relief to be mounted on the end of the jacket. The multi-core cable further includes a covering member to be fixed to the peripheries of the electric wires exposed from the jacket. The covering member is contacted with the strain relief to restrict the longitudinal-direction movement of the cable. Due to such characteristics of the multi-core cable, even when the cable is pulled, the connector attached to the cable tip end can be prevented against removal or breakage, thereby preventing the jacket against damage.

### CROSS-REFERENCE TO RELATED APPLICATION

The present application claims the benefit of priority of Japanese Patent Application No. 2015-133278, filed on Jul. 2, 2015, which is incorporated herein by reference.

### BACKGROUND

Technical Field

The invention relates to a multi-core cable and, specifically to a multi-core cable including a strain relief to be mounted on the end of a cable jacket for covering the periphery of a plurality of electric wires.

Related Art

Generally, a multi-core cable includes a strain relief which prevents the cable from being pulled out from a connector or being bent excessively. For example, the Japanese Patent No. 5228444B discloses a technology in which, in order to withstand a load along pull-out direction, the electric wires and cable jacket are caulked by an annular member, which is contacted with a strain relief.

Also, Japanese Patent publication No. 2011-90870A discloses a technology that the electric wires exposed from the cable jacket are covered by a covering member in order to meet the request to shorten the exposed length of the electric wires as much as possible as in medical equipment.

However, in the Japanese Patent, when a draw-out direction load is generated in the cable the cable jacket caulked by the annular member is thereby stretched and moved in the draw-out direction, in some cases, the ends of the electric wires within the jacket are pulled to thereby remove or break a connector attached to the tip ends of the electric wires. Also, the strain relief and jacket rub against each other, and thereby the jacket is damaged.

### SUMMARY

The invention is made in view of the above circumstances. Thus, it is an object of the invention to provide a multi-core cable which, even when the cable is pulled, a connector attached to the tip end of the cable can be prevented against removal or damage, thereby preventing a jacket against damage.

A multi-core cable includes according to an embodiment of the invention includes a plurality of electric wires, a jacket for covering the peripheries of the electric wires, and a strain relief to be mounted on the end of the jacket. The multi-core cable further includes a covering member to be fixed to the peripheries of the electric wires exposed from the jacket. The covering member is contacted with the strain relief to restrict a movement of the cable along a longitudinal-direction of the strain relief.

In the multi-core cable, even when the cable is pulled, the electric wires within the cable are prevented from moving at a portion of the tip end of the cable as extends from the strain relief,. Thus, the connector attached to the cable tip end can be prevented against removal or breakage, thereby preventing the jacket against damage.

### BRIEF DESCRIPTION OF DRAWINGS

FIG. 1 is an external appearance view of the schematic structure of a multi-core cable according to an example of the embodiment of the invention.

FIG. 2 is a sectional view of a strain relief.

FIG. 3A is a partial sectional view of the cable.

FIG. 3B is a sectional view taken along the arrow b-b shown in FIG. 3A.

FIG. 4 is a planar view of the cable and strain relief before they are engaged.

FIG. 5 is a sectional view of the cable and strain relief, showing the engaged state thereof.

FIG. 6A is a partial sectional view of a cable according to another example of the embodiment.

FIG. 6B is a sectional view taken along the arrow b-b shown in FIG. 6A.

### DETAILED DESCRIPTION

### Description of Embodiment of the Invention

A multi-core cable according to the embodiment of the invention has any one of the characteristics of the following structures (1)˜(5).

(1) A multi-core cable, comprising: a plurality of electric wires; a jacket for covering the peripheries of the electric wires; and, a strain relief to be mounted on the end of the jacket, wherein the multi-core cable further includes a covering member to be fixed to the peripheries of the electric wires exposed from the jacket, and the covering member is in contact with the strain relief to restrict a movement of the cable along a longitudinal-direction of the strain relief.

In the multi-core cable having such characteristics, in such portion of the tip end of the cable as exists forwardly of the strain relief, even when the electric wires are pulled, they are prevented against movement. Therefore, the connector attached to the tip end of the cable can be prevented against removal or breakage and further the cable jacket can be prevented against damage.

(2) A multi-core cable according to the (1) structure, wherein the inner surface of the covering member and the outer surfaces of the electric wires are adhered to each other.

Mutual adhesion between the covering member and electric wires enables the cable to withstand the draw-out direction load further firmly.

(3) A multi-core cable according to the (1) or (2) structure, wherein the covering member is a shrinkable tube formed of shrinkable resin. When the shrinkable tube is used, shrinking of the tube into the wire assembly and impregnation of the adhesive into the wire assembly can prevent the electric wires against deformation, thereby eliminating a fear that the electric wires can be crushed to impair the electric property thereof as in a structure where the jacket is caulked by metal.

(4) A multi-core cable according to any one of the (1) to (3) structures, further including a wrapping member for covering the electric wires and a shield layer for covering the periphery of the wrapping member, wherein the jacket covers the periphery of the shield layer, and the covering member is arranged directly on the peripheries of the plurality of electric wires being exposed at the end portion of the cable in which the wrapping member, shield layer and jacket are all removed. The shield layer can secure the shield property of the cable. The wrapping member can prevent the electric wires from rubbing against the shield (metal) to wear.

(5) A multi-core cable according to any one of the (1) to (4) structures, wherein the tip ends of the electric wires are connected and fixed to a connecting member. This can prevent the connecting member against removal or breakage.

### Specific Description of Embodiment of the Invention

Description is given specifically of the embodiment of the invention with reference to the drawings.

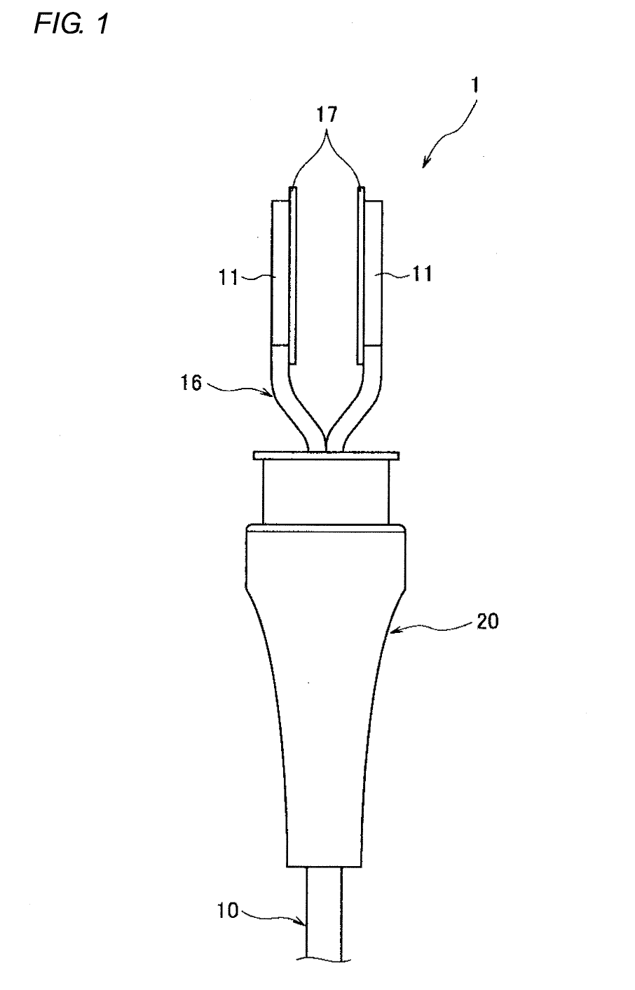

FIG. 1 is an external appearance view of the schematic structure of a multi-core cable according to an example of the embodiment of the invention. A multi-core cable 1 is constituted of a plurality of electric wires with their peripheries covered by a jacket or the like. In the end of the multi-core cable 1, the jacket is removed and the electric wires are branched to a plurality of bundles 16. In the tip ends of the bundles 16, the electric wires are separated from each other and are electrically connected to a substrate 17. On the end of a jacket 14, there is mounted a strain relief 20. The substrate 17 is also connected to a connector (not shown). The electric wires may also be connected to the connector without passing through the substrate 17. The substrate 17 and connector are connecting members.

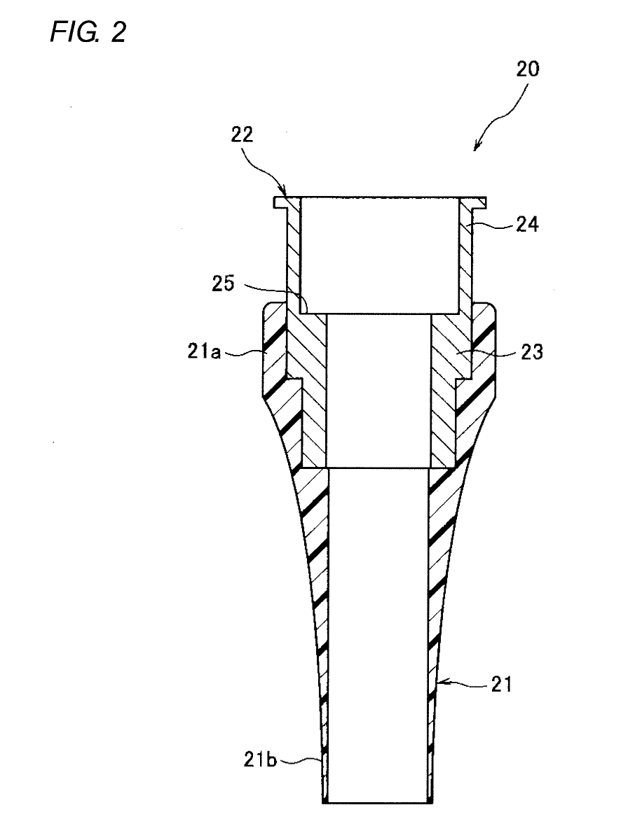

FIG. 2 is a section view of the strain relief The inner surface of the strain relief 20 is formed in a cylindrical shape capable of insertion of the jacket 14 therein and includes, for example, a relief main body 21 and a holder 22.

The relief main body 21 is formed of, for example, resin, and includes a tip end 21a larger in diameter than a rear end 21b.

The holder 22 is formed of, for example, metal and includes an engaging part 23 engageable with the tip end 21 a of the relief main body 21 and a connecting part 24 projecting outward from the tip end 21 a. On the tip end of the multi-core cable of the invention, there is mounted a casing (not shown). The connecting part 24 of the holder is a part for mounting the casing thereon. The casing covers the connecting members (that is, the substrate and connector) and electric wire terminals. The inside diameter of the connecting part 24 is larger than that of the engaging part 23, thereby forming a step 25 between the connecting part 24 and engaging part 23.

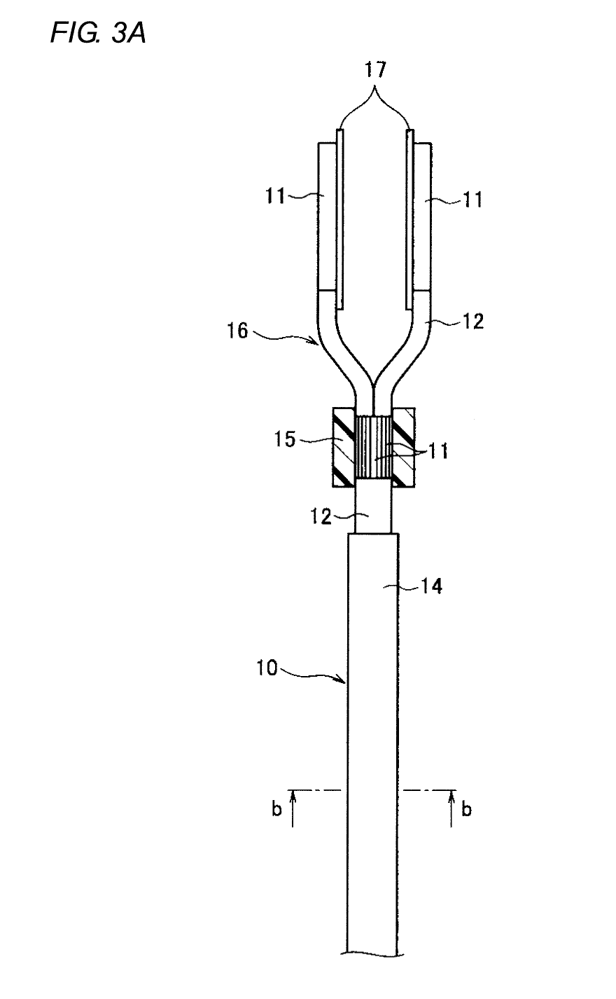

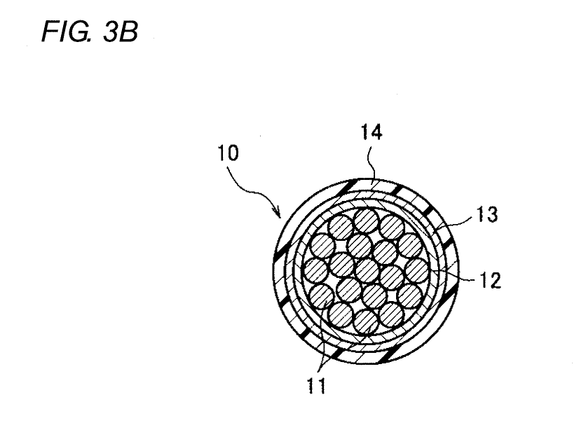

FIG. 3A is a partial sectional view of the multi-core cable 1 and FIG. 3B is a section view taken along the arrow b-b shown in FIG. 3A. As shown in FIG. 3B, a plurality of coaxial wires 11 are covered by a wrapping tape 12, a shield layer 13 and a cable jacket 14 in this order.

Each of the coaxial wires 11, although not shown, includes, in the periphery of the center conductor thereof, an insulator, an outside conductor and a jacket which are arranged coaxially with each other. Here, the coaxial wires 11 correspond to the wires of the invention. The outside diameter of each electric wire is small, specifically, 0.18˜0.4 mm.

The wrapping tape 12 is formed of, for example, a porous member of PTFE (polytetrafluoroethylene resin) and is wound spirally on the bundles of the coaxial wires 11 to gather the coaxial wires 11 in a cylindrical shape. The wrapping tape 12 is wound on a wire assembly constituted of a plurality of electric wires, whereby the assembly is fixed without loosening. The wires may also be gathered in tubes, cylindrical bodies of woven fibers or the like.

The shield layer 13 is formed by braiding, for example, annealed copper wires or copper alloy wires in order to secure a shield or reinforce mechanical strength, and covers the wrapping tape 12. It may also be a layer formed of spirally wound fine metal wires, or a layer formed of wound metal tape (including tape formed of metal foil attached to resin, or tape formed of a metal layer evaporated on resin), or a combination thereof.

The outside of the shield layer 13 is covered by the cable jacket 14 formed of, for example, PE (polyethylene), PVC (polyvinyl chloride), fluororesin, or polyester. The jacket may be an extruded resin coating or a resin tape.

Also, as shown in FIG. 3A, the wrapping tape 12 is exposed from the jacket 14. In a portion where the wrapping tape 12 is removed and electric wires are thereby exposed. A shrinkable tube (heat shrinkable tube) 15 is fixed to the exposed wire assembly (a plurality of coaxial wires 11). Here, the shrinkable tube 15 corresponds to the covering member of the invention. The wrapping tape 12 is wound on an opposite portion of the wire assembly from the shrinkable tube 15. The electric wires are branched to two or more bundles 16 according to the number of substrates to which the electric wires are connected.

The shrinkable tube 15 is formed of heat shrinkable resin mainly constituted of, for example, polyolefin, fluorine group polymer, or thermoplastic elastomer and, when heated, it is shrinkable in the diameter direction. It may also be a tube which can be shrunk by other method than heating. The outside diameter of the shrinkable tube 15 is not larger than the inside diameter of the connecting part 24 of the strain relief 20 and is larger than the inside diameter of the engaging part 23, whereby the shrinkable tube 15 can come into contact with the step 25 to restrict the movement of the strain relief from the tip end 21a toward the rear end 21b. That is, such portion of the wire assembly as exists nearer to the tip end than the shrinkable tube is prevented from being pulled into the strain relief. Here, a sleeve with a flange may also be pressed into the engaging part 23, and the flange portion may be used as the step 25. In this case, the outside diameter of the shrinkable tube 15 is set larger than the inside diameter of the sleeve.

Crushing the coaxial wires 15 and impairing an electric property of the coaxial wires 15 are preventable by using of such shrinkable tube 15.

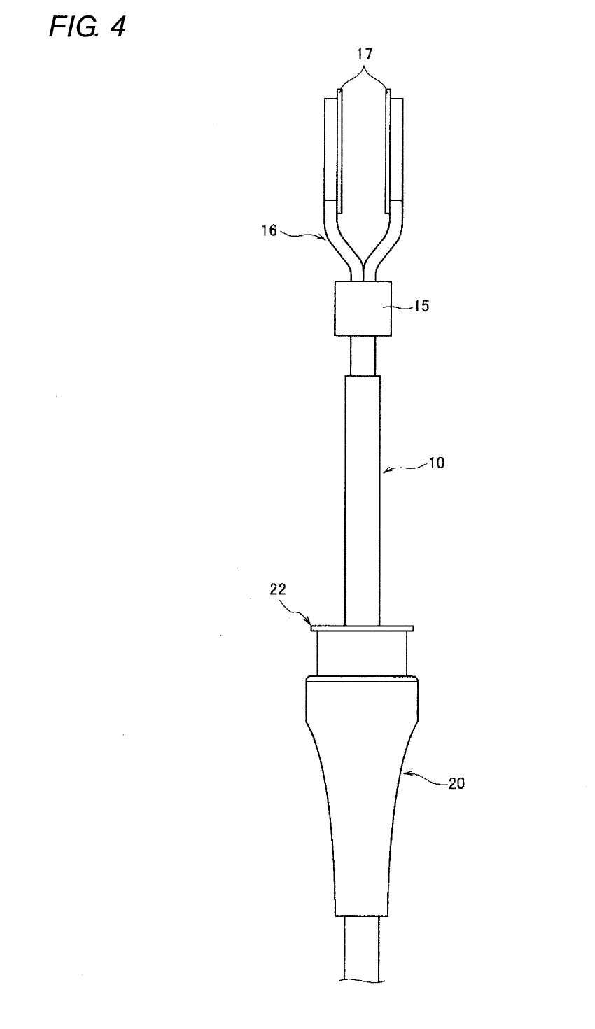

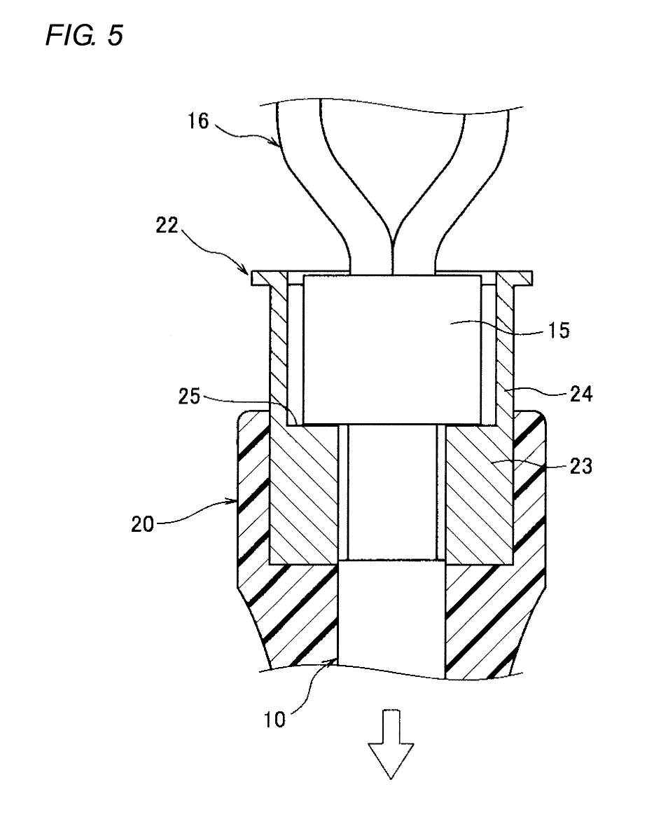

FIG. 4 shows a state before the cable 10 and strain relief are engaged with each other, and FIG. 5 is a sectional view of the cable 10 and strain relief, showing the engaged state thereof.

The strain relief 20, for example, as a pre-mounting part, is previously mounted on the cable 10. The strain relief may also be mounted onto the cable from the cable end opposite to the branching portion.

Then, the substrates 17 described in FIG. 1 are connected to equipment such as a sensor. The substrates 17 are connected to the equipment through a connector. The holder 22 of the strain relief 20 is mounted onto a casing (not shown). The shield layer 13 of the cable 10 is fixed to the casing.

In a conventional casing-equipped cable, when tensile force is applied to the cable, the portion of the wire assembly existing in and forwardly of the strain relief is moved to the rear end of the strain relief, whereby the connector is pulled and is thereby removed or broken.

However, in this embodiment, the wire assembly is fixed to the shrinkable tube and, even when the cable is pulled in the direction of the arrow shown in FIG. 5, the shrinkable tube 15 is contacted with the strain relief and is thereby prevented against movement thereby preventing the wire assembly from moving on the tip end side (within the casing) existing in and forwardly of the strain relief. This can prevent removal or breakage of the connector attached to the cable tip end and thus can prevent the cable jacket against damage.

Here, in FIG. 5, description is given of an example in which the end of the shrinkable tube is contacted with the step of the strain relief. However, the movement of the cable in the draw-out direction may also be restricted by a structure in which the engaging part 23 or the flange-equipped sleeve bites the shrinkable tube 15 to thereby engage the outer peripheral surface of the heat shrinkable tube with the engaging part 23 or the inner peripheral surface of the sleeve.

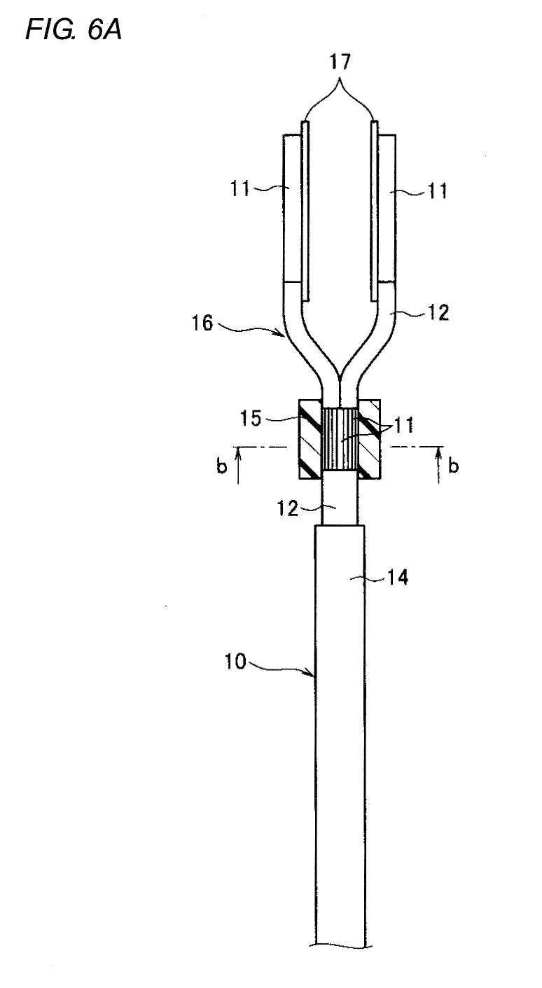

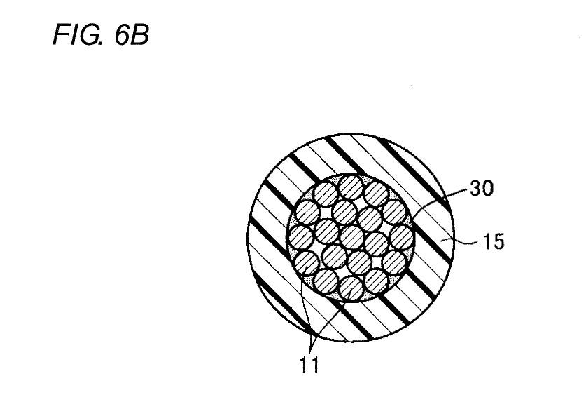

When the cable jacket 14 and the like are removed from the cable 10 the coaxial wires in the outer most layer make unevenness on the outer surfaces of the bundled coaxial wires, whereby clearances exist between the inner surface of the shrinkable tube and such outer surfaces. Therefore, as shown in FIG. 6B, preferably, the inner surface of the shrinkable tube 15 and the outer surfaces of the coaxial wires 11 may be adhered to each other by adhesive 30. In this case, the cable is enabled to withstand the draw-out direction load more firmly. Here, when the adhesive 30 is filled into the inside coaxial wires to enable adhesion of the coaxial wires to each other, the tensile force withstanding power can be enhanced further.

The above described embodiment does not limit the invention. The scope of the invention is stated by the scope of the appended claims and thus contains all changes and equivalents falling under the scope of the claims.

1. A multi-core cable, comprising:
a plurality of electric wires;
a jacket for covering the peripheries of the electric wires; and
a strain relief to be mounted on the end of the jacket,
wherein the multi-core cable further includes a covering member to be fixed to the peripheries of the electric wires exposed from the jacket, and the covering member is in contact with the strain relief to restrict a movement of the cable along a longitudinal-direction of the strain relief.

2. The multi-core cable according to claim 1, wherein the inner surface of the covering member and the outer surfaces of the electric wires are adhered to each other.

3. The multi-core cable according to claim 1, wherein the covering member is a shrinkable tube formed of shrinkable resin.

4. The multi-core cable according to claim 1, further comprising:
a wrapping member for covering the electric wires, and
a shield layer for covering the periphery of the wrapping member,
wherein the jacket covers the periphery of the shield layer, and the covering member is arranged directly on the peripheries of the plurality of electric wires being exposed at the end portion of the cable in which the wrapping member, the shield layer and the jacket are removed.

5. The multi-core cable according to claim 1, wherein the tip ends of the electric wires are connected and fixed to a connecting member.
